(19) United States
(12) Patent Application Publication
(10) Pub. No.: US 2018/0174224 A1
(43) Pub. Date: Jun. 21, 2018

(54) VECTOR-BASED CHARACTERIZATIONS OF PRODUCTS AND INDIVIDUALS WITH RESPECT TO PERSONAL PARTIALITIES

(71) Applicant: Wal-Mart Stores, Inc., Bentonville, AR (US)

(72) Inventors: Bruce W. Wilkinson, Rogers, AR (US); Todd D. Mattingly, Bentonville, AR (US)

(21) Appl. No.: 15/783,929

(22) Filed: Oct. 13, 2017

Related U.S. Application Data
(60) Provisional application No. 62/436,842, filed on Dec. 20, 2016.
(60) Provisional application No. 62/485,045, filed on Apr. 13, 2017.
(60) Provisional application No. 62/549,484, filed on Aug. 24, 2017.
(60) Provisional application No. 62/558,420, filed on Sep. 14, 2017.

(51) Int. Cl. G06Q 30/06

(52) U.S. Cl. CPC G06Q 30/0633; G06Q 30/0621

(57) ABSTRACT

A sensor is configured to obtain readings of the sensed customer physical characteristic or sensed customer activity over time. The readings form a time series of data and the sensor configured to transmit the time series of data onto a network. A control circuit is configured to receive the times series of data and transform the time series of data into a frequency series of data. to determine a primary frequency of the frequency series of data, and determine whether a primary frequency has changed by more than a predetermined amount compared to a baseline frequency. When the primary frequency has changed by more than the predetermined amount, determine an action, such than when the action is implemented, the disorder is minimized.

### RELATED APPLICATIONS

This application claims the benefit of U.S. Provisional Application No. 62/436,842, filed Dec. 20, 2016, U.S. Provisional Application No. 62/485,045, filed Apr. 13, 2017, U.S. Provisional Application No. 62/549,484, filed Aug. 24, 2017, U.S. Provisional Application No. 62/558,420, filed Sep. 14, 2017, all of which are incorporated herein by reference in their entirety.

### TECHNICAL FIELD

These teachings relate generally to providing products and services to individuals.

### BACKGROUND

Various shopping paradigms are known in the art. One approach of long-standing use essentially comprises displaying a variety of different goods at a shared physical location and allowing consumers to view/experience those offerings as they wish to thereby make their purchasing selections. This model is being increasingly challenged due at least in part to the logistical and temporal inefficiencies that accompany this approach and also because this approach does not assure that a product best suited to a particular consumer will in fact be available for that consumer to purchase at the time of their visit.

Increasing efforts are being made to present a given consumer with one or more purchasing options that are selected based upon some preference of the consumer. When done properly, this approach can help to avoid presenting the consumer with things that they might not wish to consider. That said, existing preference-based approaches nevertheless leave much to be desired. Information regarding preferences, for example, may tend to be very product specific and accordingly may have little value apart from use with a very specific product or product category. As a result, while helpful, a preferences-based approach is inherently very limited in scope and offers only a very weak platform by which to assess a wide variety of product and service categories.

### BRIEF DESCRIPTION OF THE DRAWINGS

The above needs are at least partially met through provision of the vector-based characterizations of products described in the following detailed description, particularly when studied in conjunction with the drawings, wherein:

FIG. 1 comprises a flow diagram as configured in accordance with various embodiments of these teachings;

FIG. 2 comprises a flow diagram as configured in accordance with various embodiments of these teachings;

FIG. 3 comprises a graphic representation as configured in accordance with various embodiments of these teachings;

FIG. 4 comprises a graph as configured in accordance with various embodiments of these teachings;

FIG. 5 comprises a flow diagram as configured in accordance with various embodiments of these teachings;

FIG. 6 comprises a graphic representation as configured in accordance with various embodiments of these teachings;

FIG. 7 comprises a graphic representation as configured in accordance with various embodiments of these teachings;

FIG. 8 comprises a graphic representation as configured in accordance with various embodiments of these teachings;

FIG. 9 comprises a flow diagram as configured in accordance with various embodiments of these teachings;

FIG. 10 comprises a flow diagram as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a block diagram as configured in accordance with various embodiments of these teachings;

FIG. 14 comprises a flow diagram as configured in accordance with various embodiments of these teachings;

FIG. 15 comprises a graph as configured in accordance with various embodiments of these teachings;

FIG. 16 comprises a flow diagram as configured in accordance with various embodiments of these teachings;

FIG. 17 comprises a block diagram as configured in accordance with various embodiments of these teachings;

FIG. 18 comprises a block diagram as configured in accordance with various embodiments of these teachings;

FIG. 19 comprises a flow diagram as configured in accordance with various embodiments of these teachings;

FIG. 20 comprises a block diagram as configured in accordance with various embodiments of these teachings.

FIG. 21 comprises a block diagram as configured in accordance with various embodiments of these teachings;

FIG. 22 comprises a flow diagram as configured in accordance with various embodiments of these teachings;

FIG. 23 comprises a flow diagram as configured in accordance with various embodiments of these teachings;

FIG. 24 comprises a flow diagram as configured in accordance with various embodiments of these teachings;

FIG. 25 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

So configured, these teachings can constitute, for example, a method for automatically correlating a particular product with a particular person by using a control circuit to obtain a set of rules that define the particular product from amongst a plurality of candidate products for the particular person as a function of vectorized representations of partialities for the particular person and vectorized characterizations for the candidate products. This control circuit can also obtain partiality information for the particular person in the form of a plurality of partiality vectors that each have at least one of a magnitude and an angle that corresponds to a magnitude of the particular person's belief in an amount of good that comes from an order associated with that partiality and vectorized characterizations for each of the candidate products, wherein each of the vectorized characterizations indicates a measure regarding an extent to which a corresponding one of the candidate products accords with a corresponding one of the plurality of partiality vectors. The control circuit can then generate an output comprising identification of the particular product by evaluating the partiality vectors and the vectorized characterizations against the set of rules.

The aforementioned set of rules can include, for example, comparing at least some of the partiality vectors for the particular person to each of the vectorized characterizations for each of the candidate products using vector dot product calculations. By another approach, in lieu of the foregoing or in combination therewith, the aforementioned set of rules can include using the partiality vectors and the vectorized characterizations to define a plurality of solutions that collectively form a multi-dimensional surface and selecting the particular product from the multi-dimensional surface. In such a case the set of rules can further include accessing other information (such as objective information) for the particular person comprising information other than partiality vectors and using the other information to constrain a selection area on the multi-dimensional surface from which the particular product can be selected.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

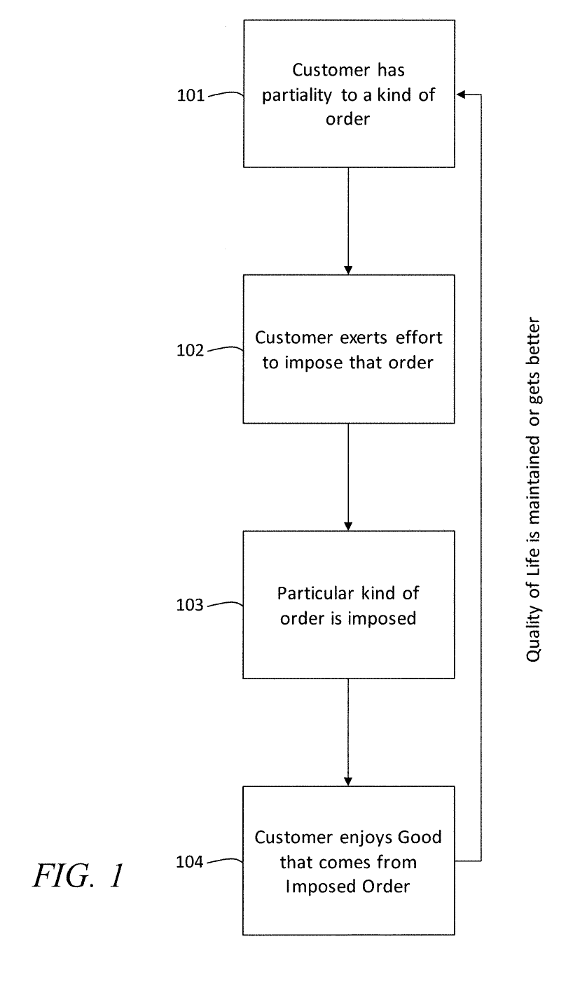

FIG. 1 provides a simple illustrative example in these regards. At block 101 it is understood that a particular person has a partiality (to a greater or lesser extent) to a particular kind of order. At block 102 that person willingly exerts of to impose that order to thereby, at block 103, achieve an arrangement to which they are partial. And at block 104, this person appreciates the “good” that comes from successfully imposing the order to which they are partial, in effect establishing a positive feedback loop.

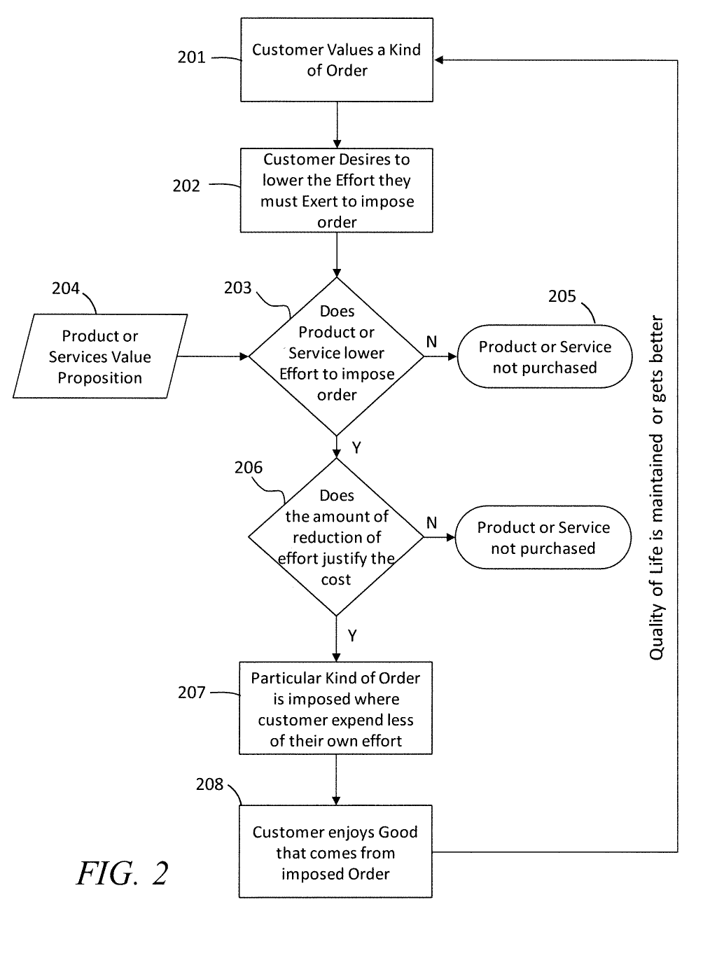

Understanding these partialities to particular kinds of order can be helpful to understanding how receptive a particular person may be to purchasing a given product or service. FIG. 2 provides a simple illustrative example in these regards. At block 201 it is understood that a particular person values a particular kind of order. At block 202 it is understood (or at least presumed) that this person wishes to lower the effort (or is at least receptive to lowering the effort) that they must personally exert to impose that order. At decision block 203 (and with access to information 204 regarding relevant products and or services) a determination can be made whether a particular product or service lowers the effort required by this person to impose the desired order. When such is not the case, it can be concluded that the person will not likely purchase such a product/service 205 (presuming better choices are available).

When the product or service does lower the effort required to impose the desired order, however, at block 206 a determination can be made as to whether the amount of the reduction of effort justifies the cost of purchasing and/or using the proffered product/service. If the cost does not justify the reduction of effort, it can again be concluded that the person will not likely purchase such a product/service 205. When the reduction of effort does justify the cost, however, this person may be presumed to want to purchase the product/service and thereby achieve the desired order (or at least an improvement with respect to that order) with less expenditure of their own personal effort (block 207) and thereby achieve, at block 208, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short-term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity; or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach; a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via. Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

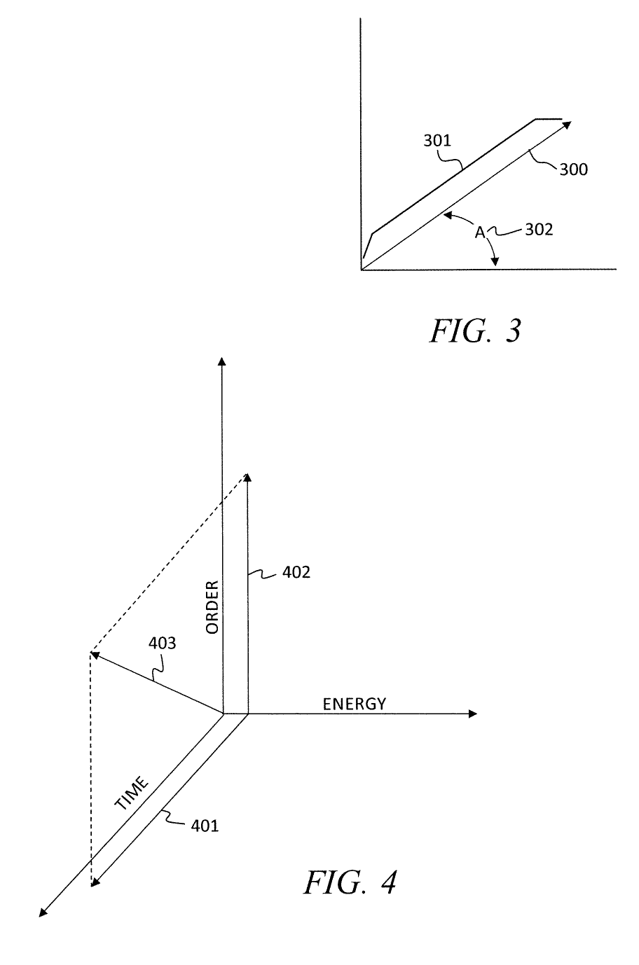

FIG. 3 provides some illustrative examples in these regards. By one approach the vector 300 has a corresponding magnitude 301 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 301, the greater the strength of that belief and vice versa. Per another example, the vector 300 has a corresponding angle A 302 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person; this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 4 presents a space graph that illustrates many of the foregoing points. A first vector 401 represents the time required to make such a wristwatch while a second vector 402 represents the order associated with such a device (in this case, that order essentially represents the skill of the craftsman). These two vectors 401 and 402 in turn sum to form a third vector 403 that constitutes a value vector for this wristwatch. This value vector 403, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may, exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired. order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience)

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

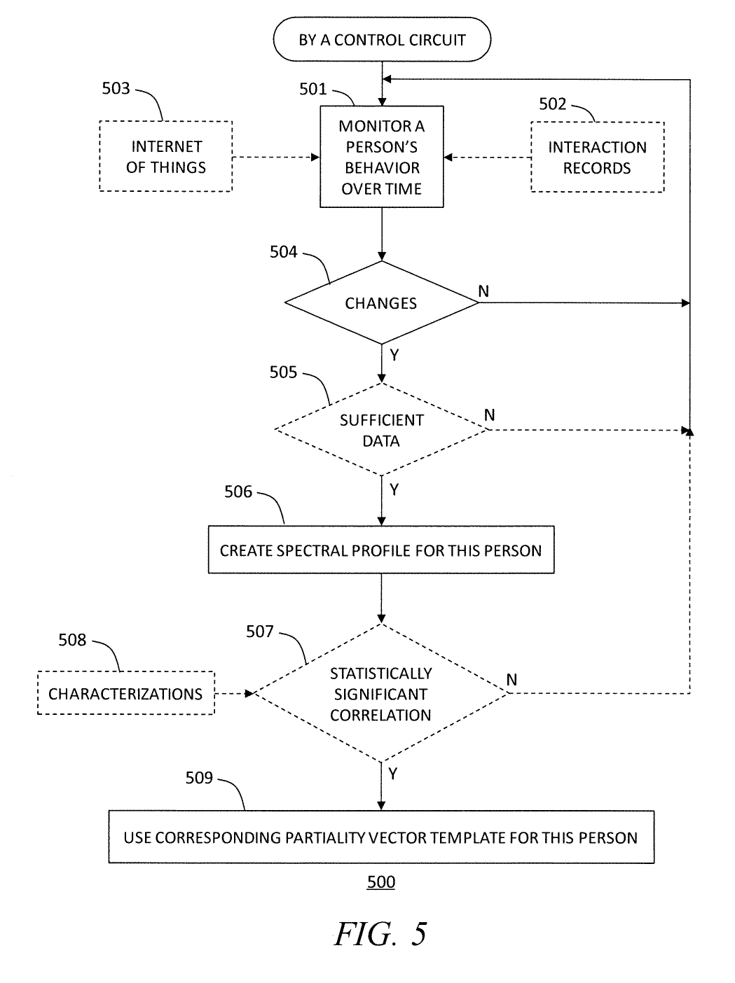

FIG. 5 presents a process 500 that illustrates yet another approach in these regards. For the sake of an illustrative example it will be presumed here that a control circuit of choice (with useful examples in these regards being presented further below) carries out one or more of the described steps/actions.

At block 501 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 502 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 502 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IOT) 503. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 500 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 504 this process 500 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 505 this process 500 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

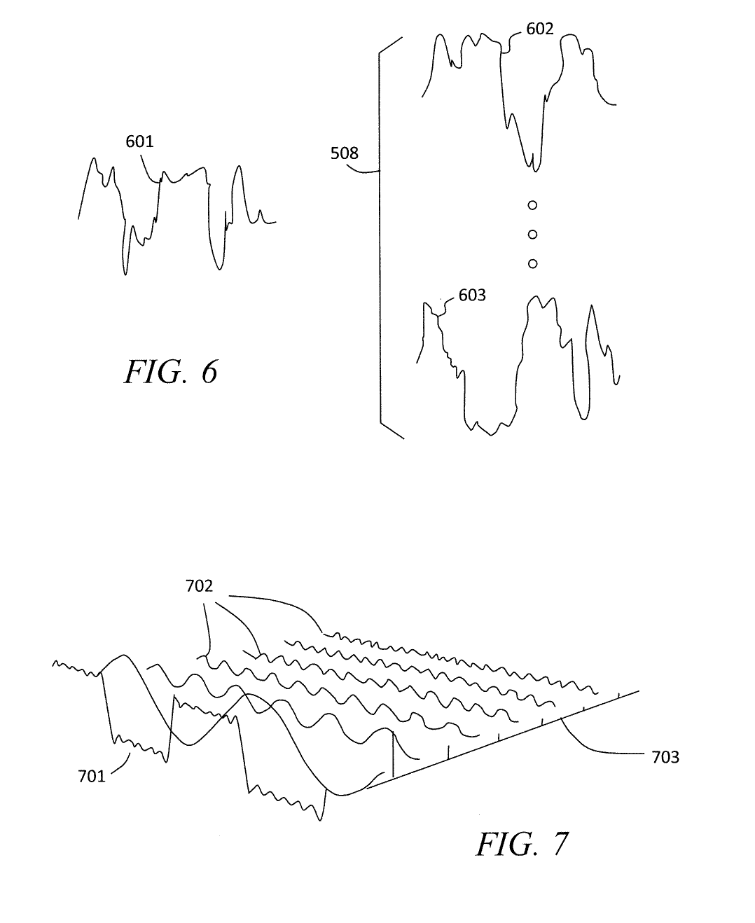

At block 507 this process 500 uses these detected changes to create a spectral profile for the monitored person. FIG. 6 provides an illustrative example in these regards with the spectral profile denoted by reference numeral 601. In this illustrative example the spectral profile 601 represents changes to the person's behavior over a given period of time (such as an hour, a day, a week, or some other temporal window of choice). Such a spectral profile can be as multidimensional as may suit the needs of a given application setting.

At optional block 507 this process 500 then provides for determining whether there is a statistically significant correlation between the aforementioned spectral profile and any of a plurality of like characterizations 508. The like characterizations 508 can comprise, for example, spectral profiles that represent an average of groupings of people who share many of the same (or all of the same) identified partialities. As a very simple illustrative example in these regards, a first such characterization 602 might represent a composite view of a first group of people who have three similar partialities but a dissimilar fourth partiality while another of the characterizations 603 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 7, by one approach the selected characterization (denoted by reference numeral 701 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 701 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 7 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 7) in the same sense as, for example, a radio or acoustic wave, it will nevertheless be understood that such a behavioral characterization 701 can itself be broken down into a plurality of sub-waves 702 that, when summed together, equal or at least approximate to some satisfactory degree the behavioral characterization 701 itself. (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 703 wherein the X axis represents frequency and the Y axis represents the magnitude of the response of the monitored person at each frequency/sub-wave of interest.

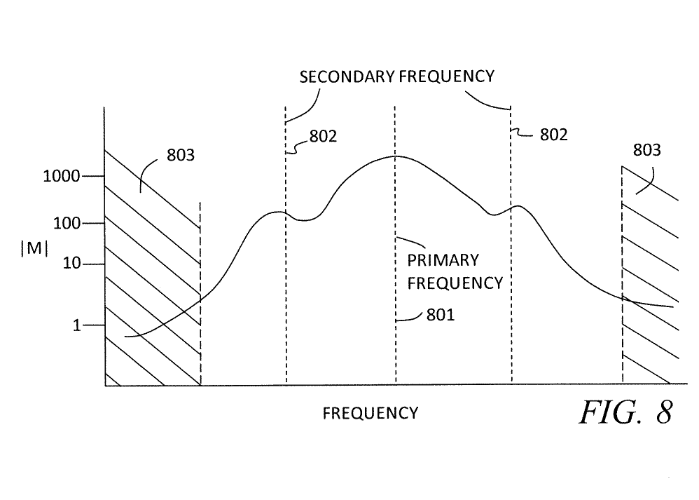

This spectral response of a given individual—which is generated from a time series of events that reflect/track that person's behavior yields frequency response characteristics for that person that are analogous to the frequency response characteristics of physical systems such as, for example, an analog or digital filter or a second order electrical or mechanical system. Referring to FIG. 8, for many people the spectral profile of the individual person will exhibit a primary frequency 801 for which the greatest response (perhaps many orders of magnitude greater than other evident frequencies) to life is exhibited and apparent. In addition, the spectral profile may also possibly identify one or more secondary frequencies 802 above and/or below that primary frequency 801. (It may be useful in many application settings to filter out more distant frequencies 803 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 701, those partialities can be used as an initial template for a person whose own behaviors permit the selection of that particular characterization 701. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

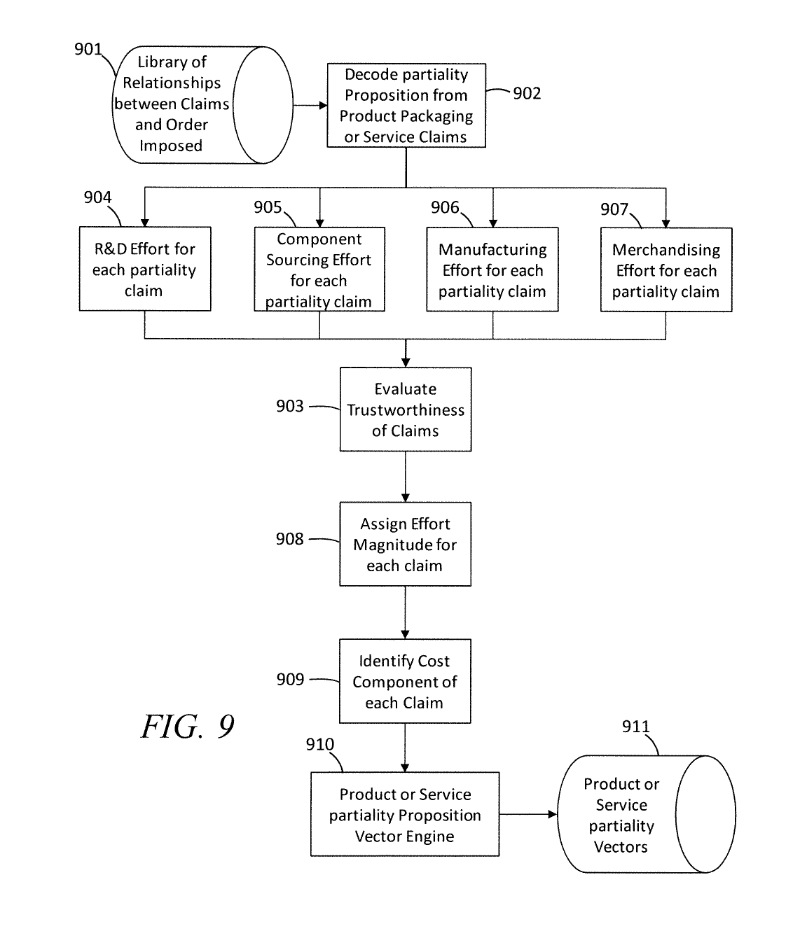

FIG. 9 presents one non-limiting illustrative example in these regards. The illustrated process presumes the availability of a library 901 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 902 this process provides for decoding one or more partiality propositions from specific product packaging (or service claims). For example, the particular textual/graphics-based claims presented on the packaging of a given product can be used to access the aforementioned library 901 to identify one or more corresponding imposed orders from which one or more corresponding partialities can then be identified.

At block 903 this process provides for evaluating the trustworthiness of the aforementioned claims. This evaluation can be based upon any one or more of a variety of data points as desired. FIG. 9 illustrates four significant possibilities in these regards. For example, at block 904 an actual or estimated research and development effort can be quantified for each claim pertaining to a partiality. At block 905 an actual or estimated component sourcing effort for the product in question can be quantified for each claim pertaining to a partiality. At block 906 an actual or estimated manufacturing effort for the product in question can be quantified for each claim pertaining to a partiality. And at block 907 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 908 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 909 this process provides for identifying a cost component of each claim, this cost component representing a monetary value. At block 910 this process can use the foregoing information with a product/service partiality propositions vector engine to generate a library 911 of one or more corresponding partiality vectors for the processed products/services. Such a library can then be used as described herein in conjunction with partiality vector information for various persons to identify, for example, products/services that are well aligned with the partialities of specific individuals.

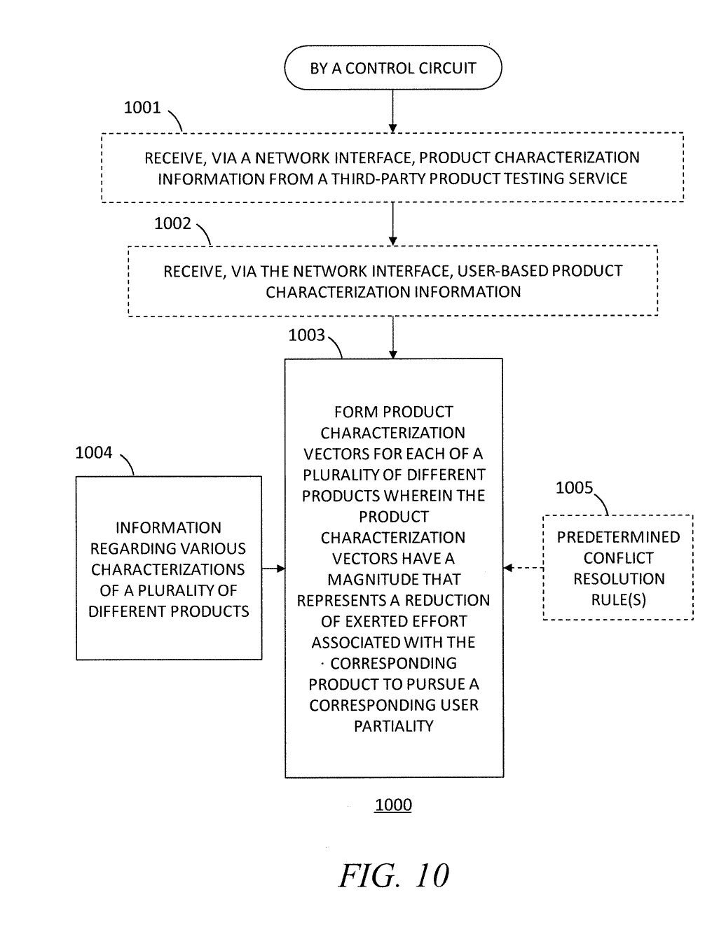

FIG. 10 provides another illustrative example in these same regards and may be employed in lieu of the foregoing or in total or partial combination therewith. Generally speaking, this process 1000 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 10, this process 1000 can be carried out by a control circuit of choice. Specific examples of control circuits are provided elsewhere herein.

As described further herein in detail, this process 1000 makes use of information regarding various characterizations of a plurality of different products. These teachings are highly flexible in practice and will accommodate a wide variety of possible information sources and types of information. By one optional approach, and as shown at optional block 1001, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1002, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1000 provides for accessing (see block 1004) information regarding various characterizations of each of a plurality of different products. This information 1004 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1004 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1003 the control circuit uses the foregoing information 1004 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1004. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1005 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1004 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

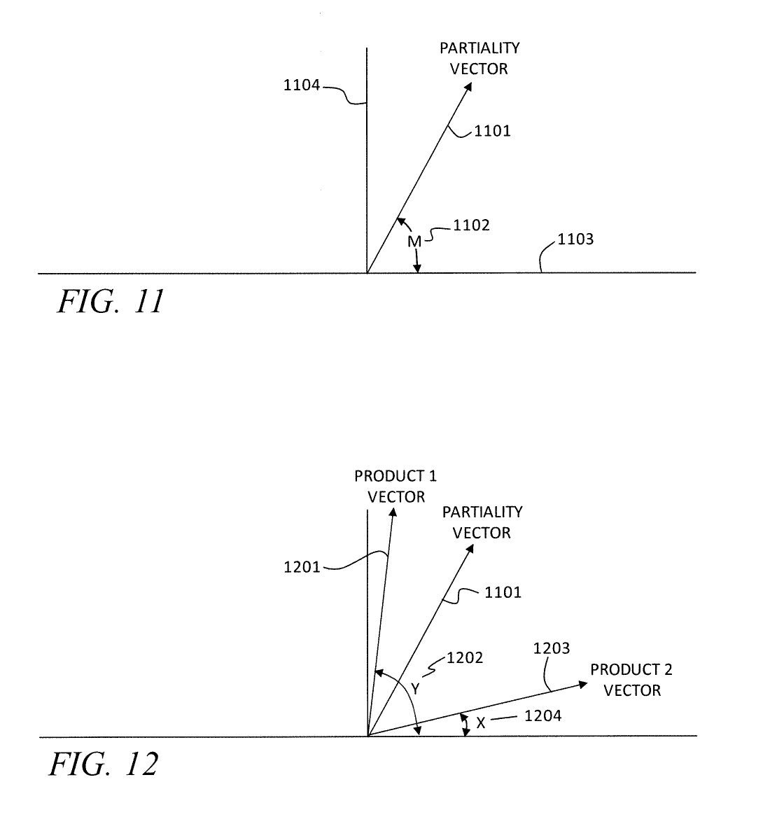

As noted above, the magnitude corresponding to a particular partiality vector for a particular person can be expressed by the angle of that partiality vector. FIG. 11 provides an illustrative example in these regards. In this example the partiality vector 1101 has an angle M 1102 (and where the range of available positive magnitudes range from a minimal magnitude represented by 0° (as denoted by reference numeral 1103) to a maximum magnitude represented by 90° (as denoted by reference numeral 1104)). Accordingly, the person to whom this partiality vector 1001 pertains has a relatively strong (but not absolute) belief in an amount of good that comes from an order associated with that partiality.

FIG. 12, in turn, presents that partiality vector 1101 in context with the product characterization vectors 1201 and 1203 for a first product and a second product, respectively. In this example the product characterization vector 1201 for the first product has an angle Y 1202 that is greater than the angle M 1102 for the aforementioned partiality vector 1101 by a relatively small amount while the product characterization vector 1203 for the second product has an angle X 1204 that is considerably smaller than the angle M 1102 for the partiality vector 1101.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1201 with the partiality vector 1101 will be larger than the resultant scaler value for the vector dot product of the product 2 vector 1203 with the partiality vector 1101. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv ·P1v) might equal (1,1), hence yielding a scalar result of ∥1∥ (where Cv refers to the corresponding partiality vector for this person and Plv represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥½∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment) Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥½∥), but the dot product for the $10/week organic apples may now drop (for example, to ∥½∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

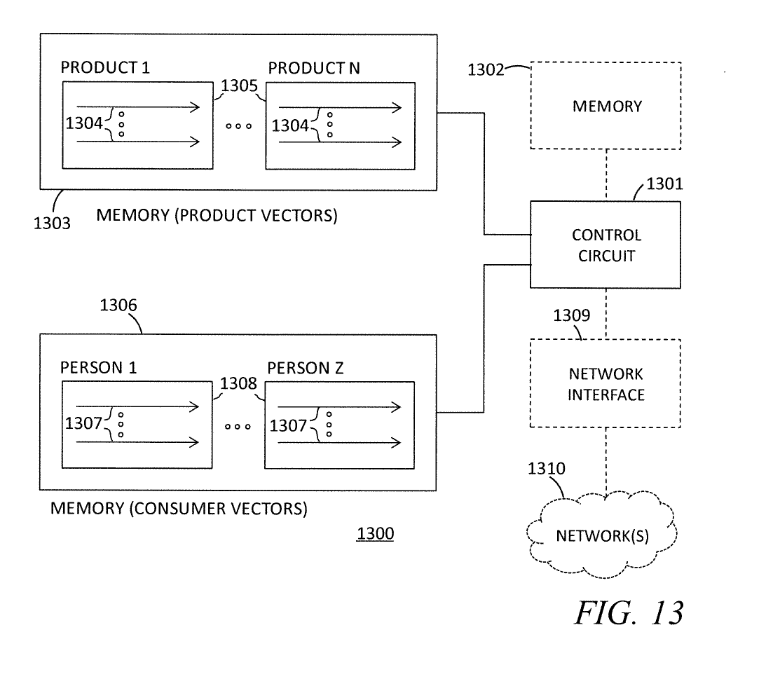

FIG. 13 presents an illustrative apparatus 1300 for conducting, containing, and utilizing the foregoing content and capabilities. In this particular example, the enabling apparatus 1300 includes a control circuit 1301. Being a “circuit,” the control circuit 1301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1301 is configured (for example, by using corresponding programming as will be well understood by those skilled in the art) to carry out one or more of the steps, actions, and/or functions described herein.

By one optional approach the control circuit 1301 operably couples to a memory 1302. This memory 1302 may be integral to the control circuit 1301 or can be physically discrete (in whole or in part) from the control circuit 1301 as desired. This memory 1302 can also be local with respect to the control circuit 1301 (where, for example, both share a common circuit board, chassis, power supply, and/or housing) or can be partially or wholly remote with respect to the control circuit 1301 (where, for example, the memory 1302 is physically located in another facility, metropolitan area, or even country as compared to the control circuit 1301).

This memory 1302 can serve, for example, to non-transitorily store the computer instructions that, when executed by the control circuit 1301, cause the control circuit 1301 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1302 or, as illustrated, in a separate memory 1303 are the vectorized characterizations 1304 for each of a plurality of products 1305 (represented here by a first product through an Nth product where “N” is an integer greater than “1”). In addition, and again either stored in this memory 1302 or, as illustrated, in a separate memory 1306 are the vectorized characterizations 1307 for each of a plurality of individual persons 1308 (represented here by a first person through a Zth person wherein “Z” is also an integer greater than “1”).

In this example the control circuit 1301 also operably couples to a network interface 1309. So configured the control circuit 1301 can communicate with other elements (both within the apparatus 1300 and external thereto) via the network interface 1309. Network interfaces, including both wireless and non-wireless platforms, are well understood in the art and require no particular elaboration here. This network interface 1309 can compatibly communicate via whatever network or networks 1310 may be appropriate to suit the particular needs of a given application setting. Both communication networks and network interfaces are well understood areas of prior art endeavor and therefore no further elaboration will be provided here in those regards for the sake of brevity.

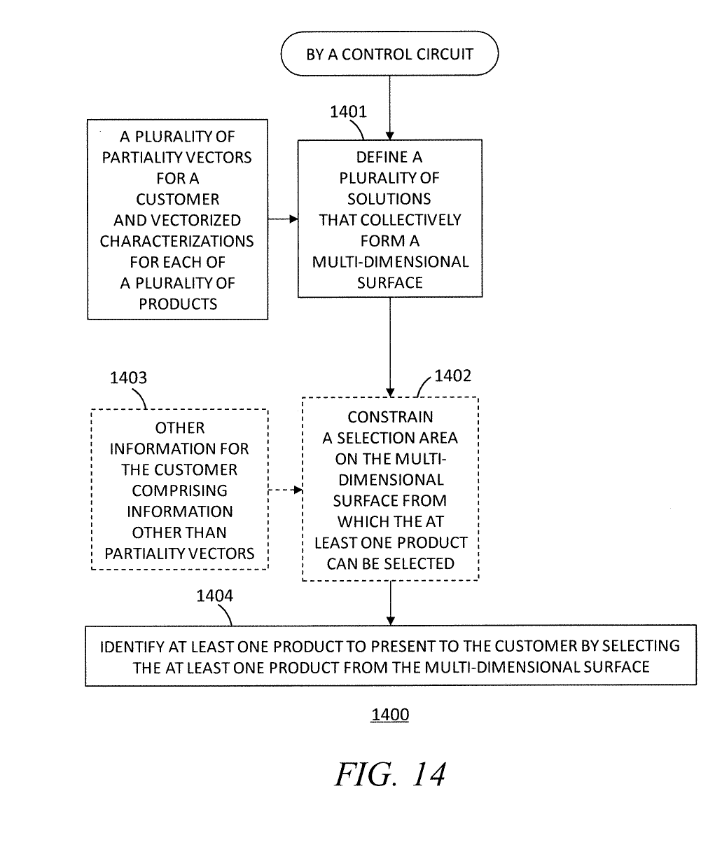

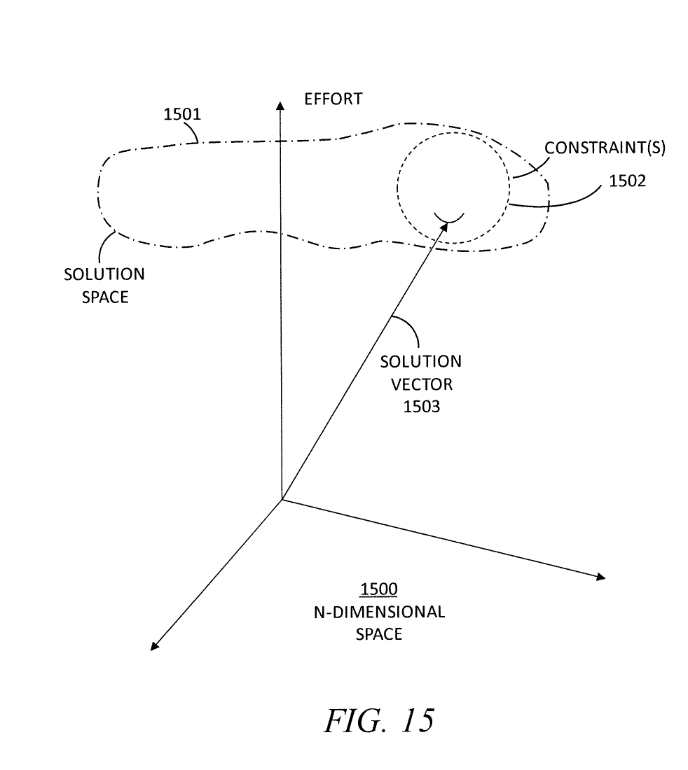

By one approach, and referring now to FIG. 14, the control circuit 1301 is configured to use the aforementioned partiality vectors 1307 and the vectorized product characterizations 1304 to define a plurality of solutions that collectively form a multidimensional surface (per block 1401). FIG. 15 provides an illustrative example in these regards. FIG. 15 represents an N-dimensional space 1500 and where the aforementioned information for a particular customer yielded a multi-dimensional surface denoted by reference numeral 1501. (The relevant value space is an N-dimensional space where the belief in the value of a particular ordering of one's life only acts on value propositions in that space as a function of a least-effort functional relationship.)

Generally speaking, this surface 1501 represents all possible solutions based upon the foregoing information. Accordingly, in a typical application setting this surface 1501 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 14 and 15, at optional block 1402 the control circuit 1301 can be configured to use information for the customer 1403 (other than the aforementioned partiality vectors 1307) to constrain a selection area 1502 on the multi-dimensional surface 1501 from which at least one product can be selected for this particular customer. By one approach, for example, the constraints can be selected such that the resultant selection area 1502 represents the best 95th percentile of the solution space. Other target sizes for the selection area 1502 are of course possible and may be useful in a given application setting.

The aforementioned other information 1403 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or plannedscheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1502), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1404 the control circuit 1301 can then identify at least one product to present to the customer by selecting that product from the multi-dimensional surface 1501. In the example of FIG. 15, where constraints have been used to define a reduced selection area 1502, the control circuit 1301 is constrained to select that product from within that selection area 1502. For example, and in accordance with the description provided herein, the control circuit 1301 can select that product via solution vector 1503 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1301 may respond per these teachings to learning that the customer is planning a party that will include seven other invited individuals. The control circuit 1301 may therefore be looking to identify one or more particular beverages to present to the customer for consideration in those regards. The aforementioned partiality vectors 1307 and vectorized product characterizations 1304 can serve to define a corresponding multi-dimensional surface 1501 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1502 to beverages that contain no alcohol. As another example in these regards, the control circuit 1301 may have objective information that the party is to be held in a state park that prohibits alcohol and may therefore similarly constrain the available selection area 1502 to beverages that contain no alcohol.

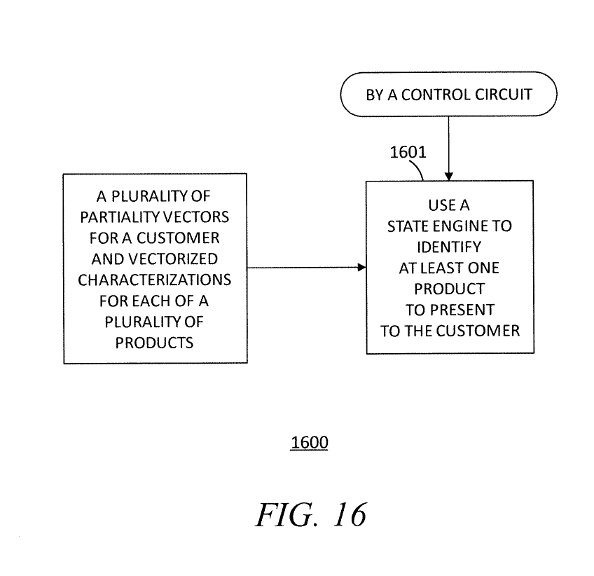

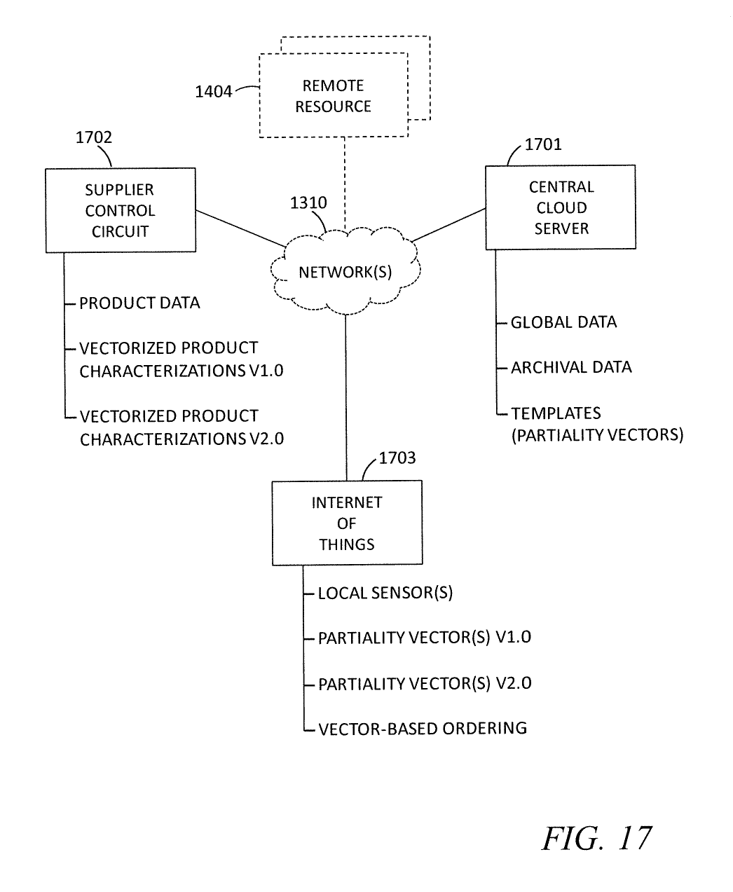

As described above, the aforementioned control circuit 1301 can utilize information including a plurality of partiality vectors for a particular customer along with vectorized product characterizations for each of a plurality of products to identify at least one product to present to a customer. By one approach 1600, and referring to FIG. 16, the control circuit 1301 can be configured as (or to use) a state engine to identify such a product (as indicated at block 1601). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

It will be appreciated that the apparatus 1300 described above can be viewed as a literal physical architecture or, if desired, as a logical construct. For example, these teachings can be enabled and operated in a highly centralized manner (as might be suggested when viewing that apparatus 1300 as a physical construct) or, conversely, can be enabled and operated in a highly decentralized manner. FIG. 17 provides an example as regards the latter.

In this illustrative example a central cloud server 1701, a supplier control circuit 1702, and the aforementioned Internet of Things 1703 communicate via the aforementioned network 1310.

The central cloud server 1701 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1701 that store identical, overlapping, or wholly distinct content.)

The supplier control circuit 1702 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 17 by the expression “vectorized product characterizations V1.0”) for a given product as well as subsequent, updated vectorized product characterizations (denoted in FIG. 17 by the expression “vectorized product characterizations V2.0”) for the same product. Such modifications may have been made by the supplier control circuit 1702 itself or may have been made in conjunction with or wholly by an external resource as desired.

The Internet of Things 1703 can comprise any of a variety of devices and components that may include local sensors that can provide information regarding a corresponding user's circumstances, behaviors, and reactions back to, for example, the aforementioned central cloud server 1701 and the supplier control circuit 1702 to facilitate the development of corresponding partiality vectors for that corresponding user. Again, however, these teachings will also support a decentralized approach. In many cases devices that are fairly considered to be members of the Internet of Things 1703 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 1702 and use that information in conjunction with local partiality vector information to facilitate the vector-based ordering.

Also, if desired, the smart phone in this example can itself modify and update partiality vectors for the corresponding user. To illustrate this idea in FIG. 17, this device can utilize, for example, information gained at least in part from local sensors to update a locally-stored partiality vector (represented in FIG. 17 by the expression “partiality vector V1.0”) to obtain an updated locally-stored partiality vector (represented in FIG. 7 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1704. These remote resources 1704 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day, is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering, additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently, unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

in examples, a “consumer personality” for a consumer (or potentially a group of customers) is determined and then, based on that personality—as quantified by the customer's partiality vectors—a match is made between the customer and products/services that most closely align with the customer's personality. In other words, a determination is made as to why, a customer prefers a product (e.g., a healthy dog food) as opposed to another product (e.g., any other dog food). Previous preferential-based systems can only observe a customer's choices and conclude that that the customer prefers to make these choices. Why the customer makes these choices is not considered by these previous approaches.

Generally speaking, a system and method are provided that restore order to a disordered situation. For example, a customer's life may become disordered, the disorder is measured, and actions are taken to restore the order.

In some of these embodiments, a system for ordering a life of a customer includes a sensor, a network, and a control circuit. The sensor is configured to obtain readings of the sensed customer physical characteristic or sensed customer activity over time. The readings form a time series of data and the sensor configured to transmit the time series of data onto the network. The network coupled to the sensor.

The control circuit is coupled to the sensor and the network, and is configured to receive the times series of data and transform the time series of data into a frequency series of data. The control circuit is configured to determine a primary frequency of the frequency series of data, and determine whether a primary frequency has changed by more than a predetermined amount compared to a baseline frequency indicating a disorder exists in an order to the life of the customer. When the primary frequency has changed by more than the predetermined amount, an action is determined, such than when the action is implemented, the disorder is minimized.

In aspects, a data storage device is configured to store a plurality of customer partiality vectors of a customer. Each of the customer partiality vectors comprises a value for a customer that is programmatically linked to a strength of the value. The customer partiality vectors of the customer collectively define the order to the life of the customer, and the data storage device includes a mapping between the primary frequencies of a sensed customer physical characteristic or a sensed customer activity, and actions. The action is determined by the mapping, such that be order as defined by the customer partiality vectors is maximized when the action is implemented.

In others of these embodiments, a system for ordering a life of a customer includes a communication network, a data storage device, a sensor, and a control circuit. The data storage device is configured to store a plurality of customer partiality vectors of a customer. Each of the customer partiality vectors comprises a value for a customer that is programmatically linked to a strength of the value. The customer partiality vectors of the customer collectively define an order to the life of the customer. The data storage device includes a mapping between primary frequencies of a sensed customer physical characteristic or a sensed customer activity, and actions.

The sensor is configured to obtain readings of the sensed customer physical characteristic or sensed customer activity over time. The readings form a time series of data, and the sensor is configured to transmit the time series of data onto the network.

The control circuit is coupled to the network and disposed at a central processing center. The control circuit is configured to receive the times series of data and transform the time series of data into a frequency series of data. The control circuit is further configured to determine a primary frequency of the frequency series of data. The control circuit is configured to determine whether the primary frequency has changed by more than a predetermined amount compared to a baseline frequency (indicating a disorder exists in the order of the life of the customer). When the primary frequency has changed by more than the predetermined amount, an action is determined according to the mapping. When the action is implemented, the disorder is minimized and the order as defined by the customer partiality, vectors is maximized.

In aspects, the readings obtained by the sensor are associated with a heartbeat, a pulse, a calorie expenditure, a breathing characteristic, a temperature, a motion, or a blood pressure of the customer.

In examples, the action is the provision of a product or a service. In other examples, the action is sending a message to a customer.

In examples, the control circuit is deployed at the cloud. In aspects, the control circuit is disposed locally at a customer site and not remotely from the customer.

In examples, the actions in the mapping change over time. In other examples, the mapping is determined by an analysis of the actions taken by other customers having the same or similar order as the customer.

In some examples, the age of the customer is used at least in part to determine the action.

In still others of these embodiments, a plurality of customer partiality vectors of a customer are stored in a data storage device. Each of the customer partiality vectors comprises a value for a customer that is programmatically linked to a strength of the value. The customer partiality vectors of the customer collectively define an order to the life of the customer. A mapping between primary frequencies of a sensed customer physical characteristic or a sensed customer activity, and actions is stored.

The readings of the sensed physical characteristic of the customer or the sensed customer activity over time are obtained. The readings form a time series of data, and the time series of data is transmitted to a control circuit via a network. The times series of data is received at the control circuit and the time series of data is transformed into a frequency series of data. At the control circuit, a primary frequency of the frequency series of data is determined. At the control circuit, a determination is made as to whether the primary frequency has changed by more than a predetermined amount compared to a baseline frequency indicating a disorder exists in the order of the life of the customer. When the primary frequency has changed by more than the predetermined amount, an action is determined according to the mapping. When the action is implemented, the disorder is minimized and the order as defined by the customer partiality vectors is maximized.

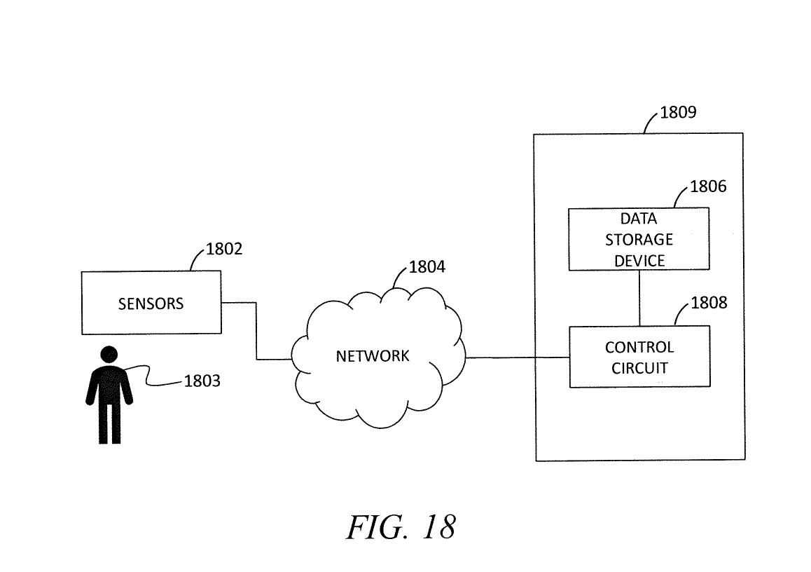

Referring now to FIG. 18, one example of a system 1800 that restores order in a customer's life is described. The system 1800 includes sensors 1802 (obtaining readings from or related to a human customer 1803), a network 1804, a data storage device 1806, and a control circuit 1808 (disposed at a central processing center 1809). In this example, the database 1806 and the control circuit 1808 are disposed at a central processing center 1809. In other examples, one or both of the database 1806 and the control circuit 1808 are disposed in close physical proximity to the customer 1803 and/or the sensors 1802.

The sensors 1802 (obtaining readings from or related to the customer 1803) may be any type of sensor that obtains readings associated with the heartbeat, the pulse, the calorie expenditure, the breathing characteristics, the temperature, the motion, or the blood pressure of the customer 1803. In these regards, the sensor may be a heartbeat monitor, pulse monitor, calorie detector, breathing sensor, thermometer, motion detector, or blood pressure monitor. Other examples of sensors are possible.

The network 1804 is an electronic communication network or combinations of networks. In aspects, the network 1804 includes electronic components such as routers, gateways, transmitters, receivers, and processors. Other examples of network components are possible.

The data storage device 1806 is any type of electronic memory storage device. The data storage device 1806 is configured to store a plurality of customer partiality vectors of a customer. Each of the customer partiality vectors comprises a value for the customer 1803 that is programmatically linked to a strength of the value. The customer partiality vectors of the customer 1803 collectively define an order to the life of the customer 1803. The data storage device 1806 also includes a mapping between primary frequencies of a sensed customer physical characteristic or a sensed customer activity, and actions. The vectors and the mapping may be implemented and stored as any appropriate data structure (e.g., a look-up table or linked list)

The control circuit 1808 is coupled to the network 1804 and disposed at the central processing center 1809. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 1808 may be configured (for example, by using corresponding programming stored in a memory as will be well understood by those skilled in the art) to carry out one or more of the steps, actions, and/or functions described herein.

The control circuit 1808 is configured to receive the times series of data and transform the time series of data into a frequency series of data. The control circuit 1808 is further configured to determine a primary frequency of the frequency series of data. The control circuit 1808 is additionally configured to determine whether the primary frequency has changed by more than a predetermined amount compared to a baseline frequency (indicating a disorder exists in the order of the life of the customer). The baseline frequency may be a historical value obtained by measuring customer activity over time. In examples, the baseline frequency may be a mean value. When the primary frequency has changed by more than the predetermined amount, an action is determined according to the mapping. The predetermined amount may be determined by an analysis of customer activity over time. When the action is implemented, the disorder is minimized and the order as defined by the customer partiality vectors is maximized.

The conversion from the time domain to the frequency domain, in aspects, reduces the amount of data significantly. In some other aspects, the higher frequencies may be full of noise and may be band-filtered to provide clean, actionable information. These approaches may focus on the primary frequency (or, in other examples, also focus on secondary and tertiary frequencies) for each customer. Smoothing algorithms may also be used to so provide the primary frequency information.

In examples, the action is the provision of a product or a service. In other examples, the action is sending an electronic message to a customer (e.g., an email).

In further examples, the control circuit 1808 is deployed at the cloud. In other aspects, the control circuit 1808 is disposed locally at a customer site (or attached to the customer in certain circumstances).

In other examples, the actions in the mapping change over time. In still other examples, the mapping is determined by an analysis of the actions taken by other customers having the same or similar order as the customer.

In yet other examples, the age of the customer is used at least in part to determine the action. For example, the action appropriate for a 20-year-old customer may be different for an action appropriate for a 70-year-old customer.

As mentioned, the control circuit can be deployed locally (with the customer). In some aspects, the Nyquist Theorem can be utilized to assign computing resources for a customer. For instance, the Nyquist Theorem allows the time sampling rate to be limited to twice the primary frequency. This relationship allows the system to allocate resources based upon the requirements of customers. For instance, customers with little variability (few data sampling points) may be handled locally by a processor with less processing power (or memory), than other customers with higher variability (more data sampling points) and needing more processing power (or more memory).

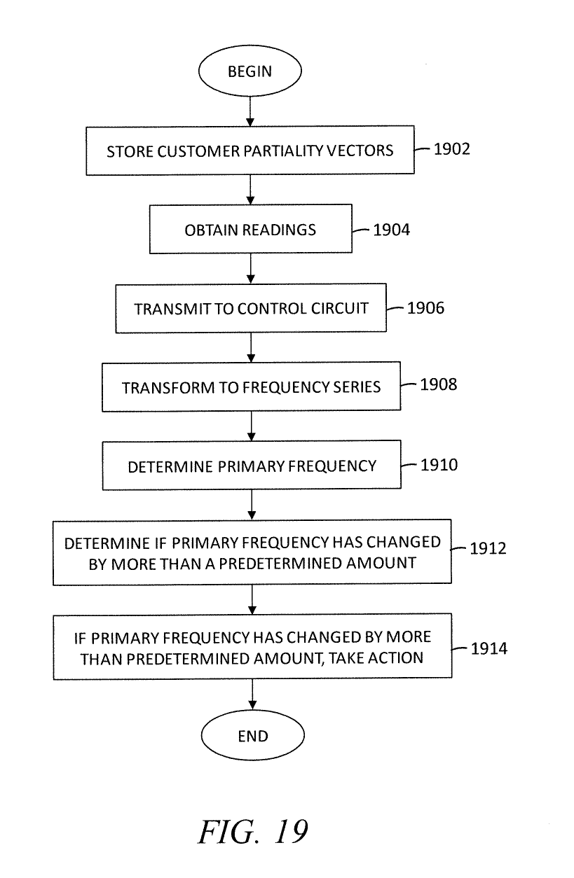

Referring now to FIG. 19, at step 1902 a plurality of customer partiality vectors associated with a customer are stored in a data storage device. Each of the customer partiality, vectors comprises a value for a customer that is programmatically linked to a strength of the value. The customer partiality vectors of the customer collectively define an order to the life of the customer. A mapping between primary frequencies of a sensed customer physical characteristic or a sensed customer activity, and actions is also stored.

At step 1904, the readings of the sensed physical characteristic of the customer or the sensed customer activity over time are obtained. In aspects, the readings may be obtained from various types of sensors that measure physical characteristics of the customer or the customer's activity such as heart rate or motion. The readings form a time series sequence of data.

At step 1906, the time series of data is transmitted to a control circuit via a network. At step 1908, the times series of data is received at the control circuit and the time series of data is transformed into a frequency series of data in the frequency domain. A Fourier transform may be used for this purpose. The Fourier transform converts the information from the time domain to the frequency domain. At step 1910 and at the control circuit, a primary frequency of the frequency series of data is determined.

At step 1912 and at the control circuit, a determination is made as to whether the primary frequency has changed by more than a predetermined amount compared to a baseline frequency indicating a disorder exists in the order of the life of the customer.

At step 1914 and when the primary frequency has changed by more than the predetermined amount, an action is determined according to the mapping. When the action is implemented, the disorder is minimized and the order as defined by the customer partiality vectors is maximized.

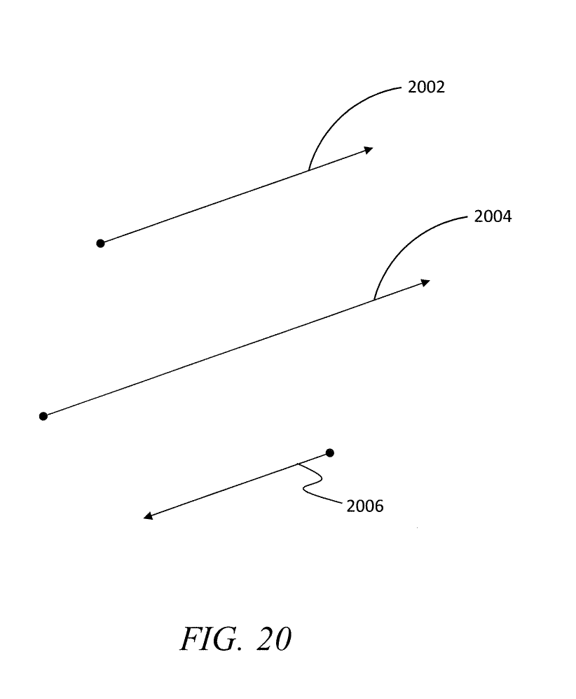

Referring now to FIG. 20, one example of the results of the present approaches is described. A first vector 2002 is a customer partiality vector. The customer partiality vector 2002 comprises a value for a customer that is programmatically linked to a strength of the value. For example, the value may be “good dental health” or “physical fitness.” In one aspect, the customer partiality vector 2002 represents normal behavior.

A second vector 2004 is a disorder vector. The disorder vector 2004 represents disorder in the life of the customer. This disorder may be sensed as has been described above, by various sensors. For example, sensors may determine that a customer is engaging in poor physical health (e.g., a sensor may sense that a customer is not exercising).

A third vector 2006 is a product characterization vector. The vector 2006 represents a product that serves to restore order to the life of the customer. For example, a product (e.g., toothpaste) that restores good dental health may be offered to the customer, or brought to the customer's attention. In other examples, the customer can be encouraged to purchase the product (e.g., with coupons, sales, and so forth). Other examples are possible. The vector sum of the vector 2006 and vector 2004 equals the vector 2002.

In some embodiments, vector-based characterizations of products and individuals with respect to personal partialities are described. Such embodiments relate generally to providing products and services to individuals.

In many of these embodiments, a sensor obtains information regarding how a customer orders their life. This information is stored as customer partiality vectors. Vectorized product characterizations (product vectors) include the amount of effort reduction a product brings. Potential products that help a customer order their lives are determined. Then, an exchange rate is determined for each product. The exchange rate is the cost to the customer of purchasing an amount of effort reduction of the potential product. Based upon the exchange rate, an action may be instigated. For example, the product may be supplied to the customer. Or, the product manufacturer may be asked to modify the product to make the product better.

In many of these embodiments, system that is configured to identify products useful in ordering the lives of customers includes a sensor, a database, and a control circuit. The sensor obtains measurement data associated with customer life ordering preferences.

The database includes a plurality of customer partiality vectors, and each of the customer partiality vectors comprises a customer life ordering preference for a customer that is programmatically linked to a strength of the customer life ordering preference. The database also includes a plurality of vectorized product characterizations, and each of the vectorized product characterizations comprises a product effort reduction characteristic that is programmatically linked to a strength of the product effort reduction characteristic. The database further stores a purchase history of the customer and earning data associated with the customer.

The control circuit is coupled to the database and the sensor. The control circuit is configured to determine potential products of interest to customer based upon an analysis of the partiality vectors of a customer, the purchase history of the customer, and the vectorized product characterizations. The control circuit is further configured to determine an exchange rate of the customer for each potential product, the exchange rate being the cost to the customer of purchasing an amount of effort reduction of the potential product. The exchange rate is determined at least in part by the earning data associated with the customer. For each of the potential products, the control circuit is configured to selectively take an action based upon the exchange rate for the potential product. The control circuit is yet further configured to selectively modify and fine-tune the customer partiality vectors as measurement data is received over time.

In aspects, the action is supplying a product to the customer. For instance, supplying a product to a customer may include identifying a supplier of the product and instigating an order of the product with the supplier. In other examples, the action is informing a manufacturer of a product to modify the product.

In examples, the sensor comprises a motion sensor, a heart rate monitor, a monitor of breathing, a thermometer, or a pressure sensor. Other examples are possible.

In still other examples, the earning data relates to the hourly salary of a customer. Other examples are possible.

In other aspects, the control circuit is further programmed to analyze the customer partiality vectors over time and identify one or more trends. For example, a single customer may be examined or several customers may be examined to determine if customer values are changing.

In others of these embodiments, measurement data associated with customer life ordering preferences is obtained using a sensor. A plurality of customer partiality vectors is stored in a database. Each of the customer partiality vectors comprises a customer life ordering preference for a customer that is programmatically linked to a strength of the customer life ordering preference.

A plurality of vectorized product characterizations is stored in the database. Each of the vectorized product characterizations comprises a product effort reduction characteristic that is programmatically linked to a strength of the product effort reduction characteristic. A purchase history of the customer and earning data associated with the customer are also stored in the database.

Potential products of interest to customer at a control circuit are determined based upon an analysis of the partiality vectors of a customer, the purchase history of the customer, and the vectorized product characterizations. Other factors may also be considered.

An exchange rate of the customer for each potential product is determined at the control circuit. The exchange rate is the cost to the customer of purchasing an amount of effort reduction of the potential product. The exchange rate is determined at least in part by the earning data associated with the customer.

For each of the potential products, an action is selectively taken by the control circuit based upon the exchange rate for the potential product. The customer partiality vectors are selectively modified and fine-tuned by the control circuit as measurement data is received over time.

In other examples and through product testing, the performance of a product is identified and quantified as to how well it works in each of several testing categories. The measures of how well the product works is quantifiable as a reduction of effort.

For example, if the skill level associated with utilizing a product is low or zero, then effort reduction may be measured in time units saved. The tester could be wearing a smart device on their wrist to measure calories expended with no products being used and then each product is used to achieve the same results. The smart device will measure the calories expended. The difference between the calories before and after product usage represent the amount of effort reduction. The amount of effort reduction would be stored as the value of a vectorized product characterization (product value vector) and may be stored in a database. In aspects, the amount of effort reduction may be represented as a ratio (e.g., 50% reduction of effort).

The customer's purchase of these products indicates their willingness to buy a reduction of effort. The cost of the product represents the money required to buy that reduction of effort. The more a customer spends on reduction of effort as a ratio of their disposable income indicates the relative value of the ordering of their lives that the product affords, which informs how much that order is valued. In aspects, the exchange rate is derived from the amount of effort expended to obtain each unit of money and the amount of reduction of effort purchased by each monetary unit (e.g., each dollar).

To take one example, a customer works 160 hours to obtain 400 disposable money units (e.g., dollars) after bills and housing. 400/160=2.5, $2.5=1 hour of effort so each dollar represents 60 min/$2.5=24 min of efforts. In this example, the customer is currently purchasing 10 minutes of effort reduction by purchasing their regular dishwashing soap for 8 minutes of $effort per load which is $0.25 per load.

For this customer and in this example, there is still an opportunity to remove 20 minutes more bringing the total effort to just loading the dishwasher without rinsing or pre-scrubbing. The cost per load to remove 15 more minutes (for a total of 25 minutes of effort reduction) would cost an additional 16 minutes of $effort which, in some examples, is not an acceptable exchange rate.

Suppose this community has 20% of the population purchasing dishwashing soap at the 10 minutes of reduced. This would leave that 20% with a 20-minute effort reduction opportunity. In this example, this data may be used to communicate a challenge to dishwashing manufacturers to provide a product that would remove a total of 20 minutes of effort for a cost of 10 minutes of effort. In aspects, a large amount of the population would find that a better deal then what they are currently purchasing. Consequently, sales of the dishwashing soap would increase.

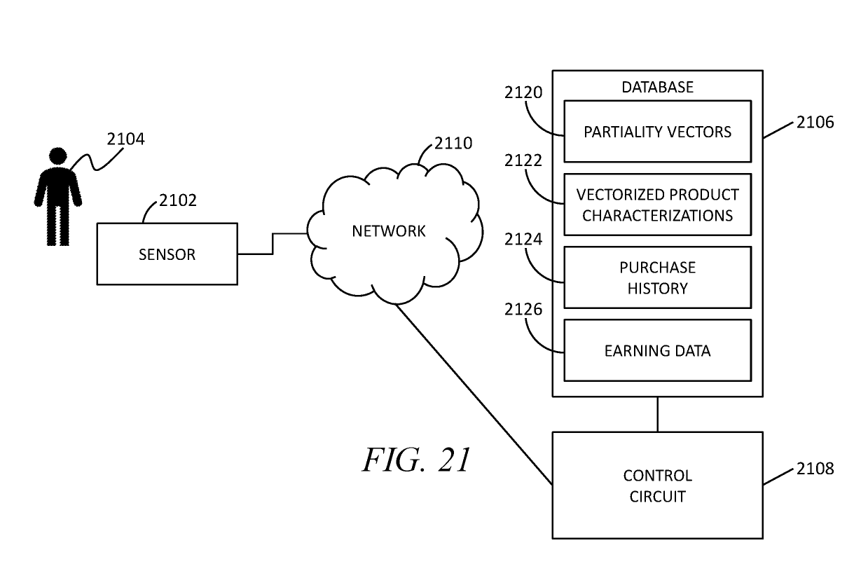

Referring now to FIG. 21, one example of a system that is configured to identify products that are useful in ordering the lives of customers is described. The system includes a sensor 2102 (that monitors a customer 2104), a database 2106, a control circuit 2108.

The sensor 2102 obtains measurement data associated with customer life ordering preferences of the customer 2104. In examples, the sensor 2102 comprises a motion sensor, a heart rate monitor, a monitor of breathing, a thermometer, or a pressure sensor. Other examples of sensors are possible.

The sensor is coupled to a network 2110. The network 2110 is also coupled to the control circuit 2108. The network 2110 may be any network or combination of networks. In examples, the network 2110 may include electronic components such as routers, gateways, and processors. Other examples of network components are possible. In one aspect, the network 2110 is the cloud network.

The database 2106 is any type of memory storage device. The database 2106 includes a plurality of customer partiality vectors 2120. Each of the customer partiality vectors 2120 comprises a customer life ordering preference for a customer that is programmatically linked to a strength of the customer life ordering preference. The database 2106 also includes a plurality of vectorized product characterizations 2122. Each of the vectorized product characterizations 2122 comprises a product effort reduction characteristic that is programmatically linked to a strength of the product effort reduction characteristic. The database 2106 further storing a purchase history 2124 of the customer 2104 and earning data 2126 associated with the customer. In examples, the earning data 2126 is the hourly salary of the customer 2104.

The control circuit 2108 is coupled to the database 2106 and the sensor 2102 (via the network 2110). It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 2108 may be configured (for example, by using corresponding programming stored in a memory as will be well understood by those skilled in the art) to carry out one or more of the steps, actions, and/or functions described herein.

The control circuit 2108 is configured to determine potential products of interest to the customer 2104 based upon an analysis of the partiality vectors 2120 of the customer 2104, the purchase history 2124 of the customer 2104, and the vectorized product characterizations 2122. The control circuit 2108 is configured to determine an exchange rate of the customer 2104 for each potential product that may be offered to the customer 2104. The exchange rate is the cost to the customer 2104 of purchasing an amount of effort reduction of the potential product. The exchange rate is determined at least in part by utilizing the earning data 2126 associated with the customer 2104. For each of the potential products, the control circuit 2108 is configured to selectively take an action based upon the exchange rate for the potential product. The action may be instigated or caused to occur using electronic control signals or electronic messages (to mention two examples) that are created by the control circuit 2108.

Data obtained by the sensor 2102 is used to selectively modify and fine-tune the customer partiality vectors 2102. As measurement data is received over time, the customer partiality vectors 2102 may change and this indicates changing life ordering preferences of the customer 2104. For example, a sensor (e.g., a motion sensor) may be attached to the customer 2104 as well as a heartrate sensor. When the motion sensor indicates a great deal of motion of the hands, the heartrate sensor indicates an elevated heart rate, and these actions occur across a predetermined amount of time at a particular time of day (e.g., around meal times), then it can be determined that the customer values clean dishes. When such activity halts for greater than a predetermined time threshold, then it can be determined that the customer no longer values clean dishes.

The value of “clean dishes” can be quantified as a customer partiality vector. Relative strengths for a customer's partiality to clean dishes can be determined and these strengths will correspond to the magnitude of the customer partiality vector. For example, if certain activity is detected 7 days per week, then (on a scale of 1 to 10), the magnitude of the vector may be set to a 10. If a moderate amount of activity is detected, then the magnitude of the customer partiality vector may be set to 5. If no activity is detected, then the magnitude of the customer partiality vector may be set to 0.

A variety of different actions are possible. In one example, the action is supplying a product to the customer 2104. Supplying the product to the customer 2104 comprises identifying a supplier of the product and instigating an order of the product with the supplier. In another example, the action is informing a manufacturer of a product to modify the product.

In still other examples, the control circuit 2108 is further programmed to analyze the customer partiality vectors 2120 over time and identify one or more trends. For example, trends in customer life ordering preferences may be evident and actions may be taken based upon the trends across a number of different customers. In one example, the trends may indicate an increase in the desirability or value of clean dishes. In this case, new products may be offered to the general population or targeted to specific customers or customer groups (e.g., based upon age or income to mention two examples).

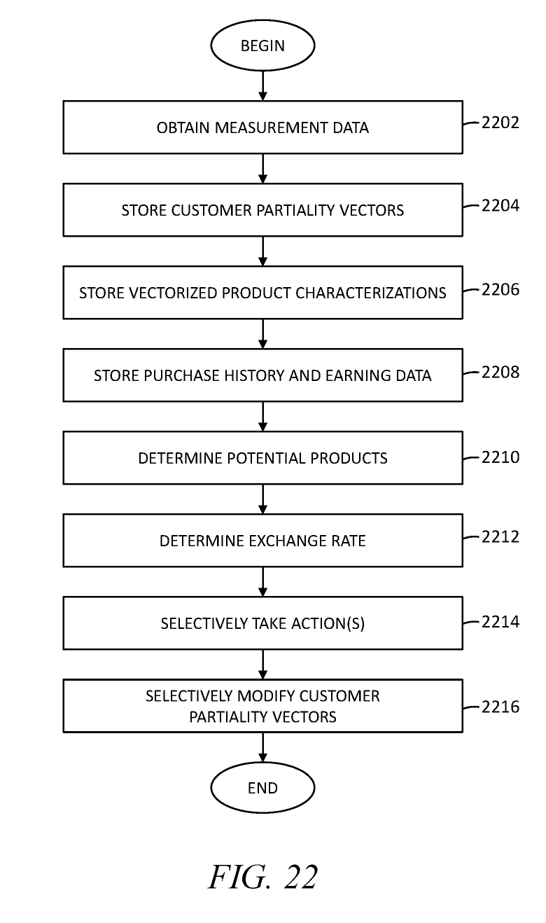

Referring now to FIG. 22, one example of a system that is configured to identify products that are useful in ordering the lives of customers is described. At step 2202, measurement data associated with customer life ordering preferences is obtained using a sensor or sensors. Sensors may include a motion sensor, a heart rate monitor, a monitor of breathing, a thermometer, or a pressure sensor. Other examples of sensors are possible.

At step 2204, a plurality of customer partiality vectors are stored in a database. Each of the customer partiality vectors comprises a customer life ordering preference for a customer that is programmatically linked to a strength of the customer life ordering preference.

At step 2206, a plurality of vectorized product characterizations are stored in the database. Each of the vectorized product characterizations comprises a product effort reduction characteristic that is programmatically linked to a strength of the product effort reduction characteristic. The vectorized product characterizations and their values may be created by testing products.

At step 2208, a purchase history of the customer and earning data associated with the customer are stored in the database. In aspects, the purchase history indicates the amount, date, and other information concerning the customer's purchases of one or more products.

At step 2210, potential products of interest to customer at a control circuit are determined based upon an analysis of the partiality vectors of a customer, the purchase history of the customer, and the vectorized product characterizations. In examples, look-up tables may be used. For example, a value of “clean dishes” may point to particular products such as specific types, brands, or product numbers of automatic dishwashers or dishwashing soap. Other examples are possible.

At step 2212, an exchange rate of the customer for each potential product is determined at the control circuit. The exchange rate is the cost to the customer of purchasing an amount of effort reduction of the potential product. The exchange rate is determined at least in part by the earning data associated with the customer. For example, the exchange rate may indicate it takes a customer 15 minutes to purchase 20 minutes of effort reduction.

At step 2214 and for each of the potential products, an action is selectively taken by the control circuit based upon the exchange rate for the potential product. The action may be instigated or caused to occur using electronic control signals or electronic messages (to mention two examples) that are created by a control circuit. In aspects and if the exchange rate is too high, then the customer may have to spend an inordinate amount of effort to obtain the product and will not be interested in obtaining the product.

At step 2216, the customer partiality vectors are selectively modified and fine-tuned by the control circuit as measurement data is received over time. For example, actions (hand movements) may be detected during or after mealtimes that indicate more people are valuing clean dishes.

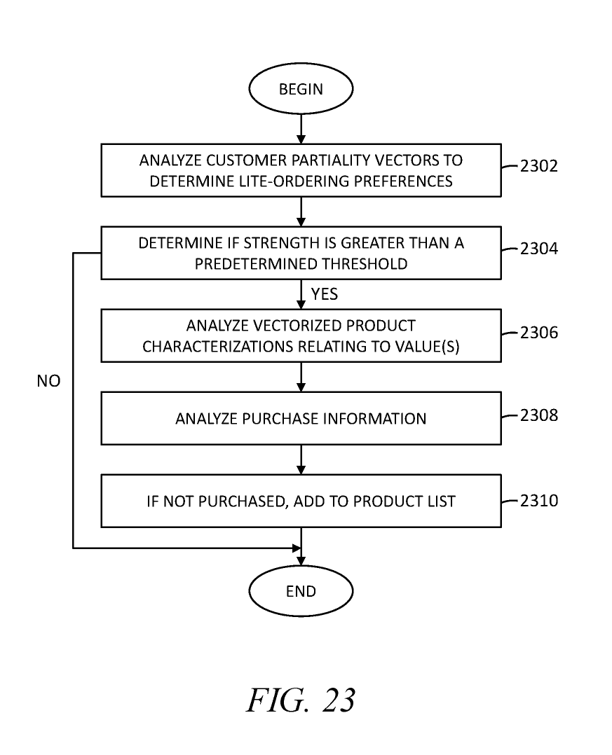

Referring now to FIG. 23, one example of an approach for the selection of potential products that can be offered to a customer is described. It will be understood that this is one example of determining the identities of potential products and that other examples are possible.

At step 2302, the customer partiality vectors are analyzed to determine customer life ordering preferences. For example, a customer partiality vector may relate to a customer partiality or preference for “clean dishes” and the strength of this vector may indicate the strength of this preference. In one example, a strength of 0 or 1 may indicate that the customer does not value clean dishes, while a value of 9 or 10 indicates that the customer has a strong preference for clean dishes.

At step 2304, it is determined if the strength is above a predetermined threshold. In one example, it may be determined if the strength is an 8 or above.

At step 2306 and when the answer at step 2304 is affirmative, vectorized product characterizations relating to the value are analyzed. In example, a look-up table may be used where a value (e.g., “clean dishes”) points to specific products (e.g., dishwashing soap, brushes, dish washers, or sponges to mention a few examples). If the answer at step 2304 is negative, execution ends.

At step 2308, the customer purchase information (information indicating the products actually purchased by the customer) is analyzed and compared to the vectorized product characterizations. For example, it may be determined whether the customer purchased various brands of dishwashing soap, brushes, dish washers, or sponges.

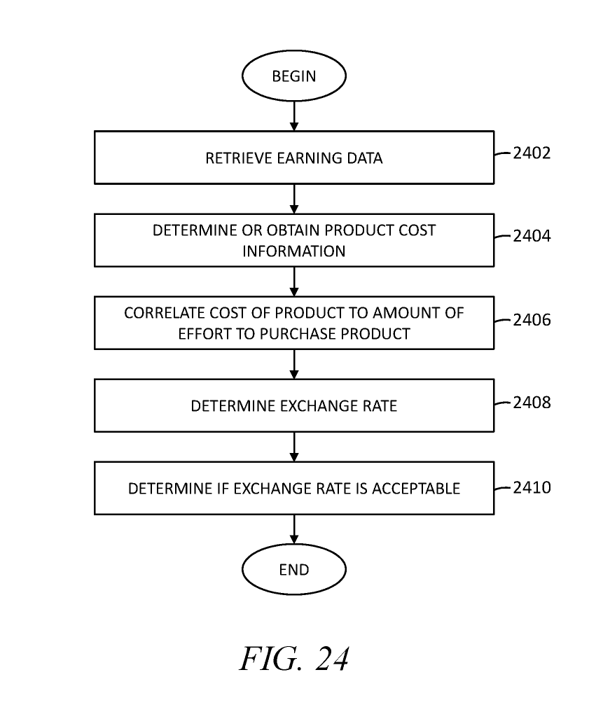

At step 2310, if the product has not been purchased it is added to a list of potential products that may be offered to the customer depending upon the exchange rate. One example of determining an exchange rate is described below with respect to FIG. 24.

Referring now to FIG. 24, one example of calculating an exchange rate of a customer for a potential product is described. The exchange rate is the cost to the customer of purchasing an amount of effort reduction of the potential product. In aspects, the exchange rate is calculated for each potential product. It will be appreciated that the approached described with respect to FIG. 24 is one example of calculating an exchange rate and that other examples are possible.

At step 2402, the customer's earning data is retrieved (e.g., from a database) to determine what the earning rate of the customer. In aspects, the earning rate of the customer may be expressed is how many monetary units are earned by the customer per unit time (e.g., dollars/hour). The information may be self-reported by the customer, or may be publicly, available information of rates earned by similarly situated customers. For example, if a customer earns $60/hour, this amounts to $1 for every minute of effort.

At step 2404, the product cost information is determined and/or analyzed. For example, a product may obtain 15 minutes of effort reduction for a cost of $60.

At step 2406, the cost of the product is correlated to the amount of effort of the customer to purchase the product. In this case, it would take $60/($60/hour) or 1 hour of customer effort to purchase the product and achieve 15 minutes of effort reduction.

At step 2408, the exchange rate is determined by correlating the cost of customer effort to the amount of effort reduction. In this case the exchange rate would be 1 hour (60 minutes) of customer effort to obtain 15 minutes of effort reduction.

At step 2410, it is determined if the exchange rate is acceptable. For example, it may be determined whether the exchange rate is below a predetermined threshold. Different customers may have different thresholds. The thresholds may also be dynamic and change over time. A customer may additionally have different thresholds for different products or product types. In this example, the threshold may be one (or less). Here, the exchange rate is 60/15=4. In this analysis, the exchange rate would not be deemed to be acceptable and no action is taken.

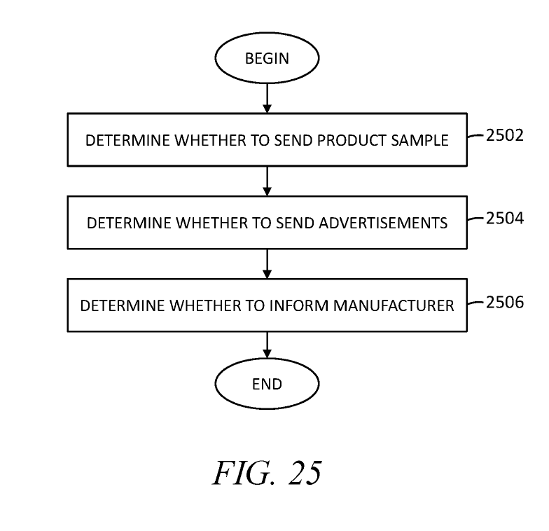

Referring now to FIG. 25, one example of an approach for determining particular actions is described. In aspects, once it has been determined that the exchange rate is acceptable, then various actions can be determined. It will be appreciated that these are examples only of potential actions and that other examples are possible.

At step 2502, it is determined whether to send a free sample of the product to the customer. In aspects, the cost of the product, and the strength of the value of the customer may be analyzed. In one specific example, when the product has a cost below a predetermined value, and when the strength of a customer's partiality vector is above a predetermined threshold, then a product can be dispatched to a customer.

At step 2504, it is determined if advertisements should be sent to the customer. For example, the cost of the product and the availability of the customer to receive advertisements may be determined. In aspects, an email address may or may not be available, and this availability may be determinative if the advertisement is sent to the customer.

At step 2506, it is determined if the manufacturer should be informed or recommendations sent to change the product. In aspects, if exchange rate calculations show that a predetermined number of customers would not want to purchase the product, then changes to the product may be recommended so that sales of the product increase. To take one specific example, if 100 customers would not wish to purchase a dishwasher soap because of unfavorable exchange rates, the product manufacturer may be informed of this fact. Changes to the product may also be suggested (e.g., changing the chemical composition of the soap to make cleaning easier to thereby increase the amount of effort reduction and lowering the price).

It will be appreciated that the actions may be implemented in a variety of different ways. For example, a control circuit may form electronic messages that are sent to customers or manufacturers. In another example, a control circuit may form an electronic signal that is effective to order a product (which is then sent to the customer by a delivery service). Other examples are possible.

In some embodiments, various methods, systems and/or apparatuses are provided. In some embodiments, a system is provided for ordering a life of a customer, the system comprising: a sensor that is configured to obtain readings of the sensed customer physical characteristic or sensed customer activity over time, the readings forming a time series of data, the sensor configured to transmit the time series of data onto the network; a network coupled to the sensor, a control circuit, the control circuit being coupled to the sensor and the network, the control circuit configured to: receive the times series of data and transform the time series of data into a frequency series of data; determine a primary frequency of the frequency series of data; determine whether a primary frequency has changed by more than a predetermined amount compared to a baseline frequency indicating a disorder exists in an order to the life of the customer; when the primary frequency has changed by more than the predetermined amount, determine an action, such than when the action is implemented, the disorder is minimized.

In some variations, the system further comprises a data storage device that is configured to store a plurality of customer partiality vectors of a customer, wherein each of the customer partiality vectors comprises a value for a customer that is programmatically linked to a strength of the value, wherein the customer partiality vectors of the customer collectively define the order to the life of the customer, wherein the data storage device includes a mapping between the primary frequencies of a sensed customer physical characteristic or a sensed customer activity, and actions; and wherein the action is determined by the mapping, and such that the order as defined by the customer partiality vectors is maximized when the action is implemented. In some embodiments, the actions in the mapping change over time. In some embodiments, the mapping is determined by an analysis of the actions taken by other customers having the same or similar order as the customer. In some embodiments, the readings are associated with a heartbeat, a pulse, a calorie expenditure, a breathing characteristic, a temperature, a motion, or a blood pressure of the customer. In some embodiments, the action is the provision of a product or a service. In some embodiments, the control circuit is deployed at the cloud. In some embodiments, the control circuit is disposed locally at a customer site and not remotely from the customer. In some embodiments, the action is sending a message to the customer. In some embodiments, the age of the customer is used at least in part to determine the action.

In some embodiments, a method is provided for ordering a life of a customer, the method comprising: obtaining readings of the sensed physical characteristic of the customer or the sensed customer activity over time, the readings forming a time series of data, and transmitting the time series of data to a control circuit; receiving the times series of data at the control circuit and transforming the time series of data into a frequency series of data; determining at the control circuit a primary frequency of the frequency series of data; determining at the control circuit whether the primary frequency has changed by more than a predetermined amount compared to a baseline frequency indicating a disorder exists in the order of the life of the customer, and when the primary frequency has changed by more than the predetermined amount, determining an action according to the mapping, such than when the action is implemented, the disorder is minimized and the order as defined by the customer partiality vectors is maximized.

In some variations, the method further comprises: storing a plurality of customer partiality vectors of a customer in a data storage device, wherein each of the customer partiality vectors comprises a value for a customer that is programmatically linked to a strength of the value, wherein the customer partiality vectors of the customer collectively define an order to the life of the customer, and storing a mapping between primary frequencies of a sensed customer physical characteristic or a sensed customer activity, and actions; and wherein the action is determined according to the mapping, such than when the action is implemented, the disorder is minimized and the order as defined by the customer partiality vectors is maximized. In some embodiments, the actions in the mapping change over time. In some embodiments, the mapping is determined by an analysis of the actions taken by other customers having the same or similar order as the customer. In some embodiments, obtaining the reading comprises obtaining a heartbeat, a pulse, a calorie expenditure, a breathing characteristic, a temperature, a motion, or a blood pressure of the customer. In some embodiments, the action is the provision of a product or a service. In some embodiments, the control circuit is deployed at the cloud. In some embodiments, the control circuit is disposed locally at a customer site and not remotely from the customer. In some embodiments, the action is sending a message to the customer. In some embodiments, the age of the customer is used at least in part to determine the action.

In some embodiments, a system is provided that is configured to identify products that are useful in ordering the lives of customers, the system comprising: a sensor that obtains measurement data associated with customer life ordering preferences; a database including a plurality of customer partiality vectors, wherein each of the customer partiality vectors comprises a customer life ordering preference for a customer that is programmatically linked to a strength of the customer life ordering preference, the database also including a plurality of vectorized product characterizations, wherein each of the vectorized product characterizations comprises a product effort reduction characteristic that is programmatically linked to a strength of the product effort reduction characteristic, the database further storing a purchase history of the customer and earning data associated with the customer; and a control circuit coupled to the database and the sensor, the control circuit being configured to: determine potential products of interest to customer based upon an analysis of the partiality vectors of a customer, the purchase history of the customer, and the vectorized product characterizations, determine an exchange rate of the customer for each potential product; the exchange rate being the cost to the customer of purchasing an amount of effort reduction of the potential product, the exchange rate being determined at least in part by the earning data associated with the customer; for each of the potential products, selectively take an action based upon the exchange rate for the potential product; selectively modify and fine-tune the customer partiality vectors as measurement data is received over time.

In some variations and embodiments, the action is supplying a product to the customer. In some variations, wherein supplying a product to a customer comprises identifying a supplier of the product and instigating an order of the product with the supplier. In some embodiments, the action is informing a manufacturer of a product to modify the product. In some embodiments, the sensor comprises a motion sensor, a heart rate monitor, a monitor of breathing, a thermometer, or a pressure sensor. In some embodiments, the earning data relates to the hourly salary of a customer. In some embodiments, the control circuit is further programmed to analyze the customer partiality vectors over time and identify one or more trends.

In some embodiments, a method is provided for determining products that are useful in ordering the lives of customers, the method comprising: obtaining measurement data associated with customer life ordering preferences using a sensor; storing a plurality of customer partiality vectors in a database, wherein each of the customer partiality vectors comprises a customer life ordering preference for a customer that is programmatically linked to a strength of the customer life ordering preference; storing a plurality of vectorized product characterizations in the database, wherein each of the vectorized product characterizations comprises a product effort reduction characteristic that is programmatically linked to a strength of the product effort reduction characteristic; storing a purchase history of the customer and earning data associated with the customer in the database; determining potential products of interest to customer at a control circuit based upon an analysis of the partiality vectors of a customer, the purchase history of the customer, and the vectorized product characterizations; determining an exchange rate of the customer for each potential product at the control circuit, the exchange rate being the cost to the customer of purchasing an amount of effort reduction of the potential product, the exchange rate being determined at least in part by the earning data associated with the customer; for each of the potential products, selectively taking an action by the control circuit based upon the exchange rate for the potential product; selectively modifying and fine-tuning the customer partiality vectors by the control circuit as measurement data is received over time.

In some variations and embodiments, the action is supplying a product to the customer. In some embodiments, supplying a product to a customer comprises identifying a supplier of the product and instigating an order of the product with the supplier. In some embodiments, the action is informing a manufacturer of a product to modify the product. In some embodiments, the sensor comprises a motion sensor, a heart rate monitor, a monitor of breathing, a thermometer, or a pressure sensor. In some embodiments, the earning data relates to the hourly salary of a customer. In some embodiments, the method includes analyzing the customer partiality vectors over time and identifying one or more trends.

This application is related to, and incorporates herein by reference in its entirety, each of the following U.S. applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30; 2016; 62/406,487 filed Oct. 11, 2016; 62/408,736 filed. Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; 62/485,045 filed Apr. 13, 2017; Ser. No. 15/487,760 filed Apr. 14, 2017; Ser. No. 15/487,538 filed Apr. 14, 2017; Ser. No. 15/487,775 filed Apr. 14, 2017; Ser. No. 15/488,107 filed Apr. 14, 2017; Ser. No. 15/488,015 filed Apr. 14, 2017; Ser. No. 15/487,728 filed Apr. 14, 2017; Ser. No. 15/487,882 filed Apr. 14, 2017; Ser. No. 15/487,826 filed Apr. 14, 2017; Ser. No. 15/487,792 filed. Apr. 14, 2017; Ser. No. 15/488,004 filed Apr. 14, 2017; Ser. No. 15/487,894 filed Apr. 14, 2017; 62/486,801, filed Apr. 18, 2017; 62/510,322, filed May 24, 2017; 62/510,317, filed May 24, 2017; Ser. No. 15/606,602; filed May 26, 2017; 62/513,490, filed Jun. 1, 2017; Ser. No. 15/624,030 filed Jun. 15, 2017; Ser. No. 15/625,599 filed Jun. 16, 2017; Ser. No. 15/628,282 filed Jun. 20, 2017; 62/523,148 filed Jun. 21, 2017; 62/525,304 filed Jun. 27, 2017; Ser. No. 15/634,862. filed Jun. 27, 2017; 62/527,445 filed Jun. 30, 2017; Ser. No. 15/655,339 filed Jul. 20, 2017; Ser. No. 15/669,546 filed Aug. 4, 2017; and 62/542,664 filed Aug. 8, 2017; 62/542,896 filed Aug. 9, 2017; Ser. No. 15/678,608 filed Aug. 16; 2017; 62/548,503 filed Aug. 22, 2017; 62/549,484 filed Aug. 24, 2017; 15/685,981 filed Aug. 24, 2017; 62/558,420 filed Sep. 14, 2017; Ser. No. 15/704,878 filed Sep. 14, 2017; and 62/559,128 filed Sep. 15, 2017.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system for ordering a life of a customer; the system comprising:
a sensor that is configured to obtain readings of the sensed customer physical characteristic or sensed customer activity over time, the readings forming a time series of data, the sensor configured to transmit the time series of data onto the network;
a network coupled to the sensor,
a control circuit, the control circuit being coupled to the sensor and the network, the control circuit configured to:
receive the times series of data and transform the time series of data into a frequency series of data;
determine a primary frequency of the frequency series of data;
determine whether a primary frequency has changed by more than a predetermined amount compared to a baseline frequency indicating a disorder exists in an order to the life of the customer;
when the primary frequency has changed by more than the predetermined amount, determine an action; such than when the action is implemented, the disorder is minimized.

2. The system of claim 1, further comprising:
a data storage device that is configured to store a plurality of customer partiality vectors of a customer, wherein each of the customer partiality vectors comprises a value for a customer that is programmatically linked to a strength of the value, wherein the customer partiality vectors of the customer collectively define the order to the life of the customer, wherein the data storage device includes a mapping between the primary frequencies of a sensed customer physical characteristic or a sensed customer activity, and actions;
and wherein the action is determined by the mapping, and such that the order as defined by the customer partiality vectors is maximized when the action is implemented.

3. The system of claim 2, wherein the actions in the mapping change over time.

4. The system of claim 2, wherein the mapping is determined by an analysis of the actions taken by other customers having the same or similar order as the customer.

5. The system of claim 1, wherein the readings are associated with a heartbeat, a pulse, a calorie expenditure, a breathing characteristic, a temperature, a motion, or a blood pressure of the customer.

6. The system of claim 1, wherein the action is the provision of a product or a service.

7. The system of claim 1, wherein the control circuit is deployed at the cloud.

8. The system of claim 1, wherein the control circuit is disposed locally at a customer site and not remotely from the customer.

9. The system of claim 1, wherein the action is sending a message to the customer.

10. The system of claim 1, wherein the age of the customer is used at least in part to determine the action.

11. A method for ordering a life of a customer, the method comprising:
obtaining readings of the sensed physical characteristic of the customer or the sensed customer activity over time, the readings forming a time series of data, and transmitting the time series of data to a control circuit;
receiving the times series of data at the control circuit and transforming the time series of data into a frequency series of data;
determining at the control circuit a primary frequency of the frequency series of data;
determining at the control circuit whether the primary frequency has changed by more than a predetermined amount compared to a baseline frequency indicating a disorder exists in the order of the life of the customer, and when the primary frequency has changed by more than the predetermined amount, determining an action according to the mapping, such than when the action is implemented, the disorder is minimized and the order as defined by the customer partiality vectors is maximized.

12. The method of claim 11, further comprising:
storing a plurality of customer partiality vectors of a customer in a data storage device, wherein each of the customer partiality vectors comprises a value for a customer that is programmatically linked to a strength of the value, wherein the customer partiality vectors of the customer collectively define an order to the life of the customer, and storing a mapping between primary frequencies of a sensed customer physical characteristic or a sensed customer activity, and actions; and
wherein the action is determined according to the mapping, such than when the action is implemented, the disorder is minimized and the order as defined by the customer partiality vectors is maximized.

13. The method of claim 12, wherein the actions in the mapping change over time.

14. The method of claim 12, wherein the mapping is determined by an analysis of the actions taken by other customers having the same or similar order as the customer.

15. The method of claim 11, wherein obtaining the reading comprises obtaining a heartbeat, a pulse, a calorie expenditure, a breathing characteristic, a temperature, a motion, or a blood pressure of the customer.

16. The method of claim 11, wherein the action is the provision of a product or a service.

17. The method of claim 11, wherein the control circuit is deployed at the cloud.

18. The method of claim 11, wherein the control circuit is disposed locally at a customer site and not remotely from the customer.

19. The method of claim 11, wherein the action is sending a message to the customer.

20. The method of claim 11, wherein the age of the customer is used at least in part to determine the action.
